(19) United States
(12) Patent Application Publication
(10) Pub. No.: US 2008/0271145 A1
(43) Pub. Date: Oct. 30, 2008

(54) Tamper indication system and method for a computing system

(76) Inventor: Mark R. Schiller, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,217

(22) Filed: Apr. 30, 2007

(51) Int. Cl. G06F 21/00

(52) U.S. Cl. 726/23

(57) ABSTRACT

A tamper indication system for a computing system comprises a sensor reader configured to determine a state of a tamper sensor of the computing system, and firmware disposed in the computing system and configured to cause a report to evidence whether the report has been tampered with, the report indicating the state of the tamper sensor.

### BACKGROUND

When passing through security checkpoints, such as security checkpoints at airports, computing systems are often subjected to a “power-on” test that is intended to ascertain whether the computing system is a legitimately operating computing system. However, such tests are often incomplete from a security standpoint. For example, a digital media drive (DMD) may have been removed from a notebook computer and replaced with a case holding contraband, but a “power-on” test is unlikely to uncover such a replacement. Further, tamper-evident adhesive labels can be used to indicate removal of parts from a computing system or an opening of the case, but replacement labels can be applied in place of the damaged originals in order to erase the evidence of tampering.

### BRIEF DESCRIPTION OF THE DRAWINGS

For a more complete understanding of the present application, the objects and advantages thereof, reference is now made to the following descriptions taken in conjunction with the accompanying drawings, in which:

FIG. 1 is a diagram illustrating an embodiment of a tamper indication system for a computing system;

FIG. 2 is a diagram illustrating an embodiment of a tamper indication method for a computing system; and

FIG. 3 is another diagram illustrating an embodiment of a tamper indication method for a computing system.

### DETAILED DESCRIPTION OF THE DRAWINGS

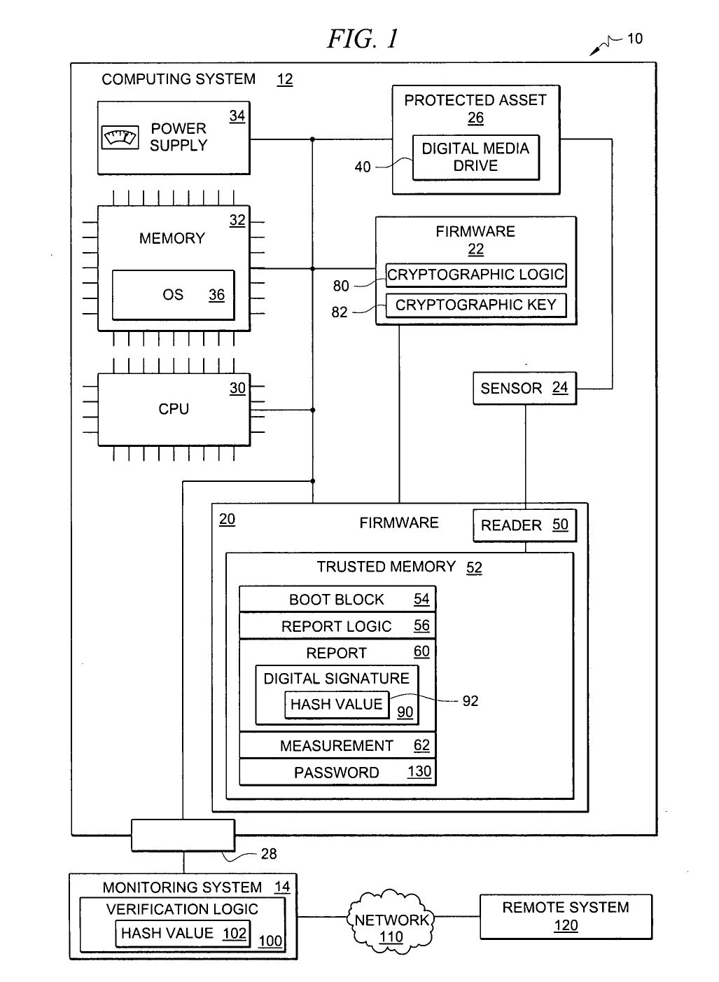

FIG. 1 is a diagram illustrating an embodiment of a tamper indication system 10. In the embodiment illustrated in FIG. 1, tamper indication system 10 is utilized to determine whether tampering has occurred for a computing system 12. In FIG. 1, tamper indication system 10 comprises a monitoring system 14 coupled to computing system 12 to ascertain whether computing system 12 has been subjected to physical tampering. Computing system 12 and/or monitoring system 14 may comprise any type of computing device such as, but not limited to, a notebook computer, tablet computer, a media player, a gaming device, a personal digital assistant (PDA), a desktop computer, and a printer.

In the embodiment illustrated in FIG. 1, computing system 12 comprises a firmware 20, a firmware 22, a tamper sensor 24, a protected asset 26, an input/output port 28, central processing unit (CPU) 30, a memory 32 and a power supply 34. In FIG. 1, firmware 20 is coupled to at least CPU 30, memory 32, firmware 22, tamper sensor 24 and power supply 34. Firmware 20 is configured to provide boot-up and/or pre-boot-up functionality for computing system 12. For example, in some embodiments, firmware 20 executes initial power-on instructions such as configuring CPU 30 and causing CPU 30 to begin executing instructions at a predetermined time. Firmware 20 may comprise a basic input/output system (BIOS), an Extensible Firmware Interface (EFI) or a Uniform EFI (UEFI). However, it should be understood that firmware 20 may comprise other systems or devices for providing boot-up and/or pre-boot-up functionality. Memory 32 may comprise volatile memory, non-volatile memory and permanent storage. In FIG. 1, memory 32 comprises an instance of an operating system (OS) 36 that may be loaded and/or otherwise executed by CPU 30. In the embodiment illustrated in FIG. 1, computing system 12 is shown as comprising a single CPU 30, although it should be understood that a greater quantity of CPUs may be used. Port 28 may comprise any type of wired or wireless interface for enabling communications between computing system 12 and monitoring system 14.

Firmware 20 is configured to determine a state of sensor 24 (e.g. whether sensor 24 is in a state signifying a tamper event occurred) during boot-up of computing system 12. Sensor 24 is coupled, mechanically and/or electrically, to protected asset 26, thereby enabling sensor 24 to sense and/or otherwise detect a change to and/or tampering of protected asset 26. Tamper sensor 24 may be disposed in or coupled to computing system 12. Protected asset 26 may be disposed in or externally coupled to computing system 12. For example, protected asset 26 may comprise a digital media drive (DMD), a battery, an access panel, a circuit, an input/output device, or any other device where it is desired to ascertain whether the particular asset has been subject to tampering. For example, in some embodiments, protected asset 26 comprises a DMD 40 and sensor 24 comprises a thin wire or optical fiber configured to break if protected asset 26 (e.g., DMD 40) is removed from computing system 12. By attempting to sense a current, voltage, electrical resistance or optical signal associated with sensor 24, firmware 20 is configured to determine whether sensor 24 has been broken, thereby indicating that protected asset 26 may have been removed and/or replaced. It should be understood that sensor 24 may comprise any type of sensor with a state determinable by firmware 20, such as an electrical switch, a magnetic switch, a proximity indicator, and an environmental sensor. It should be further understood that other forms of tampering, including opening, inserting a device, substance or signal, and causing changes in configuration or operation, may also be detected by embodiments of sensor 24.

In the embodiment illustrated in FIG. 1, firmware 20 is further configured to report the state of sensor 24 to monitoring system 14 via port 28, thereby providing tamper indication for protected asset 26 to a system external to computing system 12. In some embodiments, firmware 20 is configured to report and/or otherwise store an indication of the state of sensor 24 to memory 32, and CPU 30 is configured to report the state of sensor 24 from memory 32 to monitoring system 14 via port 28. In the embodiment illustrated in FIG. 1, firmware 20 comprises a sensor reader 50 for reading the state of sensor 24. In FIG. 1, firmware 20 also comprises a trusted memory 52 having a boot block 54, report logic 56 for generating a report 60 indicating the state of sensor 24, and a previously-recorded measurement 62 for comparison with a measurement from sensor reader 50. As used herein, “trust” or “trusted” means the expectation of consistent operation within a predefined set of rules that is enforced by computing hardware and/or software, such as the definition of “trust” as set forth in the TCG Specification Architecture Overview Specification, Revision 1.2 (Trusted Computing Group, 2004). For example, ensuring that the contents of a certain section of memory, such as memory 52 in firmware 20, contains only information produced by a previously-identified source, defined as a trusted source, enables the trust of that certain section of memory. Sensor reader 50 may either be coupled to or within trusted memory 52 to report the measurement of sensor 24 to logic 56. Boot block 54, residing in trusted memory 52, is generally the initial logic executed by firmware 20 when computing system 12 is powered on, restarted and/or reset. In some embodiments, boot block 54 is trusted logic because boot block 54 is entirely contained within trusted memory 52.

In the embodiment illustrated in FIG. 1, firmware 22 is used to render report 60 tamper-evident. For example, in the embodiment illustrated in FIG. 1, firmware 22 comprises cryptographic logic 80 and an encryption key 82. In some embodiments, cryptographic logic 80 provides cryptographic capability for computing system 12 by performing digital signature, encryption, decryption and/or hashing functions. In some embodiments, encryption key 82 comprises a public encryption key suitable for use in digitally signing and/or encrypting report 60. In some embodiments encryption key 82 is stored in firmware 20 and/or memory 32. In some embodiments, firmware 22 comprises a Trusted Platform Module (TPM). However, it should be understood that in some embodiments, the cryptographic functions identified in the illustrated embodiment as provided by firmware 22 may be provided instead by firmware 20.

In the embodiment illustrated in FIG. 1, report 60 comprises a digital signature 90, which renders alteration of and/or tampering with the contents of report 60 evident when digital signature 90 is verified. In some embodiments, report 60 may be encrypted in place of or in addition to being digitally signed. Digital signature 90 comprises an alphanumeric sequence generated by firmware 22, thereby providing a basis for verifying the integrity of report 60. For example, digital signature 90 may comprise a hash value 92 generated for report 60. Hash value 92 is a number or value uniquely representing the contents of report 60. If report 60 were altered after digital signature 90 was created, then when report 60 is subjected to a hash function at a later time, such as, by monitoring system 14, the newly calculated hash value will not match the value 92 reported in digital signature 90. Further, encryption of report 60 and/or a portion of digital signature 90 using encryption key 82 enables integrity verification of report 60. If report 60 and/or digital signature 90 were altered after encryption, then a decryption process performed by monitoring system 14 would return an invalid result that did not match an expected result.

In the embodiment illustrated in FIG. 1, monitoring system 14 comprises verification logic 100 configured to verify the integrity of report 60 and further to determine the state of sensor 24 from report 60. In some embodiments, verification logic 100 is configured to hash and decrypt report 60 and compare a hash value 102 calculated by verification logic 100 with hash value 92 calculated by firmware 22 and reported as part of digital signature 90. In the illustrated embodiment, monitoring system 14 is coupled to a network 110, thereby enabling monitoring system 14 to provide a notification or alert to a remote system 120 regarding the tampering status of computing system 12. In some embodiments, verification logic 100 may reside in remote system 120.

In operation, for example, in response to a user powering up computing system 12, power supply 34 provides power to at least firmware 20. Firmware 20 begins executing instructions in boot block 54 which is occurring before CPU 30 is operable to execute OS 36 instructions. Sensor reader 50 reads the state of tamper sensor 24 and/or any other tamper sensors coupled to firmware 20, and logic 56 determines the state of tamper sensor 24 by comparing the currently-measured state with previously-recorded measurement 62. Logic 56 then generates report 60, which is digitally signed and/or encrypted by firmware 22, thereby rendering report 60 tamper-evident. For example, in the embodiment illustrated in FIG. 1, report 60 comprises digital signature 90, which renders alteration of and/or tampering with the contents of report 60 evident when digital signature 90 is verified (e.g., by monitoring system 14). In FIG. 1, report 60 is residing in trusted memory 52 and is available for export via port 28 prior to CPU 30 being operable to execute instructions. After generation of report 60, firmware 20 continues the boot-up process and directs CPU 30 to begin executing instructions and load OS 36 from memory 32. Thus, by the stage in the power-on/boot-up process that CPU 30 is able to execute OS 36 instructions, report 60 is already generated and rendered tamper-evident. Therefore, attempting to modify the contents of report 60 in trusted memory 52 using CPU 30 would leave evidence that report 60 has been altered.

Thus, if protected asset 26 had been tampered with, sensor 24 will detect the physical tampering and the evidence of tampering will be reflected in the generation of report 60. If report 60 is then altered in an attempt to delete any indication of tampering with protected asset 26, the alteration of report 60 will be detectable. In some embodiments, monitoring system 14 is configured to validate and/or otherwise verify the integrity of report 60 by either using digital signature 90 and/or analyzing the results of decrypting an encrypted report 60. If report 60 has been tampered with, for example to conceal the tampering of protected asset 26, monitoring system 14 is able to determine that report 60 is not reliable. If monitoring system 14 validates the integrity of report 60, the contents of report 60 may be used to determine whether protected asset 26 has been tampered with.

Accordingly, for example, if computing system 12 comprises a notebook computer being transported through a security checkpoint, monitoring system 14 may be configured to form part of the checkpoint security system, and remote system 120 may comprise a computing system located in a remote security office. In response to computing system 12 being subjected to a “power-on” test, firmware 20 will generate report 60. Monitoring system 14, located at the security checkpoint, is configured to import report 60 from computing system 12. If verification logic 100 identifies tampering of report 60 and/or report 60 indicates tampering of protected asset 26, a security alert may be generated to appear at monitoring system 14 and/or remote system 120.

In some embodiments, protected asset 26 may comprise an asset that is subject to modification, removal or opening during repair, use and upgrading of computing system 12. In some embodiments, report logic 56 is further configured to read the state of sensor 24 after an authorized modification, removal or opening of protected asset 26 and update measurement 62 in trusted memory 52 subject to the entry of a security password matching a password 130 stored in trusted memory 52. For example, in some embodiments, measurement 62 comprises an alphanumeric sequence representing information uniquely identifying protected asset 26, such as a serial number permanently burned into a memory of protected asset 26 that is read by sensor 24. Changing protected asset 26 will result in sensor 24 reading a different alphanumeric sequence. In some embodiments, report logic 56 is configured to enable measurement 62 to be updated by an authorized party, for example, a network administrator with knowledge of password 130

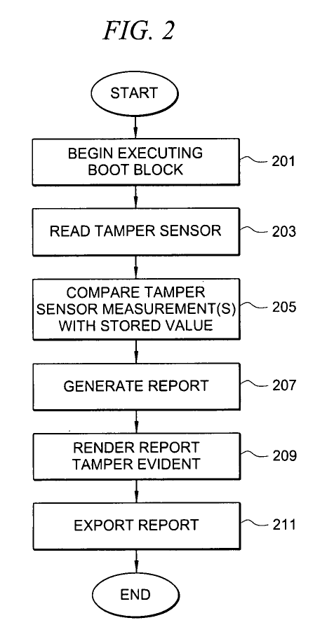

FIG. 2 is a diagram illustrating an embodiment of a tamper indication method for a computing system. The method begins at block 201, where firmware 20 begins executing boot block 54. At block 203, firmware 20 and/or sensor reader 50 reads sensor 24. At block 205, report logic 56 in firmware 20 compares the read measurement of sensor 24 with previously-recorded measurement 62. At block 207, report logic 56 generates report 60. At block 209, firmware 22 renders report 60 tamper evident by encrypting report 60 and/or generating/using digital signature 90. At block 211, report 60 is exported, such as by firmware 20, to monitoring system 14 via port 28 (report 60 may also be exported to memory 32 and then exported to monitoring system 14 by CPU 30).

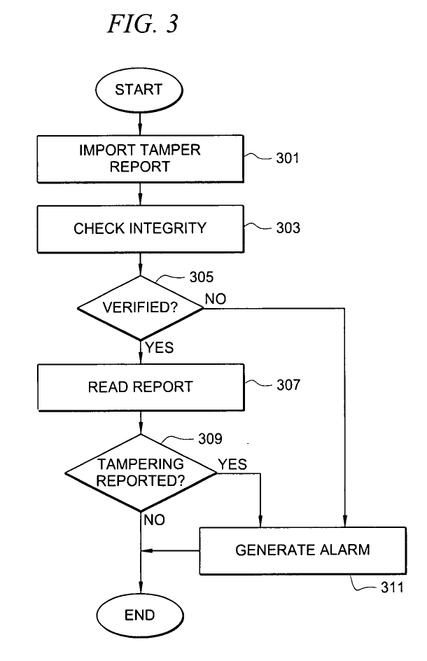

FIG. 3 is another diagram illustrating an embodiment of a tamper indication method for a computing system. The method begins at block 301, where monitoring system 14 imports and/or otherwise receives report 60. At block 303, verification logic 100 verifies the integrity of report 60 (e.g., by hashing and decrypting report 60 and compare a hash value 102 calculated by verification logic 100 with hash value 92 calculated by firmware 22 and reported as part of digital signature 90). At decision block 305, a determination is made if the integrity of report 60 is verified. If the integrity of report 60 is verified, the method proceeds to block 307, where verification logic 100 reads report 60 to ascertain whether report 60 indicates tampering of protected asset 26. At decision block 309, a determination is made as to whether report 60 indicates that tampering of protected asset 24 has occurred. If an indication of tampering is present, the method proceeds to block 311, where an alarm or other indication of the tampering is generated. If at decision block 309 it is determined that report 60 does not indicate tampering, the method ends. If at decision block 309 the integrity of report 60 is not verified, the method proceeds from decision block 309 to block 311 where an alarm or other indication of report 60 tampering is generated.

Thus, embodiments of system 10 enable a determination as to whether a computing device has been tampered with by using measurements taken and/or otherwise acquired by trusted components of the computing device. It should be understood that in the described methods, certain functions may be omitted, accomplished in a sequence different from that depicted in FIG. 2, or performed simultaneously. Also, it should be understood that the methods depicted in FIGS. 2 and 3 may be altered to encompass any of the other features or aspects as described elsewhere in the specification. Further, embodiments may be implemented in software and can be adapted to run on different platforms and operating systems. In particular, functions implemented by logic 56, logic 80, and logic 100, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electro-magnetic, infrared, or semi-conductor system, apparatus, device, or propagation medium.

What is claimed is:

1. A tamper indication method for a computing system, comprising:
determining a state of a tamper sensor of the computing system during a boot process of the computing system; and
causing a report to evidence whether the report has been tampered with, the report indicating the state of the tamper sensor.

2. The method of claim 1, further comprising comparing the state of the tamper sensor with a previously-recorded measurement.

3. The method of claim 1, further comprising determining the state of the tamper sensor prior to a central processing unit (CPU) of the computing system executing instructions associated with an operating system for the computing system.

4. The method of claim 1, further comprising digitally signing the report.

5. The method of claim 1, further comprising encrypting the report.

6. The method of claim 1, further comprising storing the report in a trusted firmware memory.

7. The method of claim 1, further comprising exporting the report to an external monitoring system.

8. The method of claim 1, further comprising verifying an integrity of the report by a monitoring system external to the computing system.

9. A tamper indication system for a computing system, comprising:
a sensor reader configured to determine a state of a tamper sensor of the computing system; and
firmware disposed in the computing system and configured to cause a report to evidence whether the report has been tampered with, the report indicating the state of the tamper sensor.

10. The system of claim 9, wherein the report is stored in a trusted firmware memory.

11. The system of claim 9, further comprising logic configured to compare the state of the tamper sensor with a previously-recorded measurement.

12. The system of claim 9, wherein the firmware is configured to digitally sign the report.

13. The system of claim 9, wherein the firmware is configured to encrypt the report.

14. The system of claim 9, further comprising logic configured to generate the report prior to causing a central processing unit (CPU) of the computing system to execute instructions associated with an operating system for the computing system.

15. The system of claim 9, further comprising logic configured to export the report to a monitoring system external to the computing system.

16. The system of claim 9, further comprising a monitoring system configured to verify an integrity of the report received from the computing system.

17. A tamper indication method for a computing system, comprising:
receiving a report generated by a trusted firmware of the computing system, the report indicating whether a tamper sensor of the computing system has been subject to tampering.

18. The method of claim 17, further comprising verifying an integrity of the report.

19. The method of claim 17, further comprising verifying an integrity of the report by verifying a digital signature of the report.

20. The method of claim 17, further comprising verifying an integrity of the report by decrypting the report.

21. A tamper indication system for a computing system, comprising:
a monitoring system configured to receive a report generated by a trusted firmware of the computing system, the report indicating whether a tamper sensor of the computing system has been subject to tampering.

22. The system of claim 21, wherein the monitoring system is configured to verify an integrity of the report.

23. The system of claim 21, wherein the monitoring system is configured to verify a digital signature of the report.
